(19) United States
(12) Patent Application Publication
(10) Pub. No.: US 2023/0420789 A1
(43) Pub. Date: Dec. 28, 2023

(54) BATTERY PACK AND POWER TOOL

(71) Applicant: Nanjing Chervon Industry Co., Ltd., Nanjing (CN)

(72) Inventors: Guiwu Hu, Nanjing (CN); Dong Yang, Nanjing (CN); Binbin Gong, Nanjing (CN); Dezhong Yang, Nanjing (CN); Junya Duan, Nanjing (CN)

(21) Appl. No.: 18/465,649

(22) Filed: Sep. 12, 2023

Related U.S. Application Data
(63) Continuation of application No. PCT/CN2022/078981, filed on Mar. 3, 2022.

(30) Foreign Application Priority Data
Apr. 15, 2021 (CN) 202110403306.1
Apr. 15, 2021 (CN) 202110403389.4
Apr. 15, 2021 (CN) 202110403460.9
May 12, 2021 (CN) 202110517154.8
May 12, 2021 (CN) 202110519193.1

(51) Int. Cl. H01M 50/291; H01M 50/293; H01M 50/247; H01M 10/653; H01M 10/6235; H01M 50/211

(52) U.S. Cl. CPC H01M 50/291; H01M 50/293; H01M 50/247; H01M 10/653; H01M 10/6235; H01M 50/211

(57) ABSTRACT

A battery pack includes a housing; a cell assembly including multiple stacked cell units; elastic pads separately disposed between adjacent ones of the multiple cell units, where air cavities are formed between the elastic pads and the adjacent ones of the multiple cell units; a sealing member disposed at least on the surface of the cell assembly, where the sealing member and the housing form a sealed chamber; and an air-permeable element partially disposed on the side surface of the cell assembly and extending into multiple air cavities along the first direction, where the air-permeable element connects with the air outside the sealed chamber.

### RELATED APPLICATION INFORMATION

This application is a continuation of International Application Number PCT/CN2022/078981, filed on Mar. 3, 2022, through which this application also claims the benefit under 35 U.S.C. § 119(a) of Chinese Patent Application No. 202110403306.1, filed on Apr. 15, 2021, Chinese Patent Application No. 202110403389.4, filed on Apr. 15, 2021, Chinese Patent Application No. 202110403460.9, filed on Apr. 15, 2021, Chinese Patent Application No. 202110517154.8, filed on May 12, 2021, and Chinese Patent Application No. 202110519193.1, filed on May 12, 2021, which applications are incorporated herein by reference in their entireties.

### TECHNICAL FIELD

The present application relates to a battery pack, for example, a battery pack applicable to a power tool.

### BACKGROUND

In recent years, with the popularity of power tools, battery packs applicable to the power tools have gradually been widely used. Due to the dustproof and waterproof requirements of the battery pack, in the related art, generally, cell units in the battery pack are stacked layer by layer and then sealed with the sealant. When the battery pack is stored at high temperatures or in the process of charging and discharging, the air pressure in the sealed space increases as the temperature rises and squeezes the cell units, and the air pressure squeezes the cells, causes the cells to move toward two sides of a stacking surface, and finally squeezes and deforms the plastic housing, affecting the appearance of the product.

### SUMMARY

A battery pack is configured to supply power to a power tool. The battery pack includes a housing; a cell assembly disposed in the housing and including multiple stacked cell units; elastic pads separately disposed between adjacent ones of the multiple cell units, where air cavities are formed between the elastic pads and the adjacent ones of the multiple cell units; a sealing member disposed at least on the surface of the cell assembly, where the sealing member and the housing form a sealed chamber; and an air-permeable element partially disposed on the side surface of the cell assembly and extending into multiple air cavities along the first direction, where the air-permeable element connects with the air outside the sealed chamber.

In some examples, the air-permeable element includes an air-permeable body and multiple air-permeable pin ends, and the multiple air-permeable pin ends are connected to the air-permeable body.

In some examples, the air-permeable body is disposed on the side surface of the cell assembly, and one of the multiple air-permeable pin ends is at least partially located in one of the multiple air cavities.

In some examples, the upper surface of the air-permeable body is higher than the upper surface of the sealing member.

In some examples, the upper surface of the air-permeable body is flush with the upper surface of the sealing member.

In some examples, a groove is formed on the upper surface of the sealing member, and the upper surface of the air-permeable body is flush with the upper surface of the sealing member where the groove is located.

In some examples, the air-permeable element is made of waterproof air-permeable material.

In some examples, the thickness of the air-permeable element is greater than 0.3 mm and less than 4 mm.

In some examples, the elastic pads are configured to be deformation-reversible material.

In some examples, each of the elastic pads is configured to be thermally conductive material or includes a heat conducting component.

In some examples, an opening is formed on a side of each of the elastic pads facing the air-permeable element, and the air in the opening connects with the air in one of the multiple air cavities.

In some examples, the housing includes an upper housing and a lower housing, the sealing member and the lower housing form the sealed chamber, and the cell assembly is disposed in the sealed chamber.

In some examples, separating ribs are formed on the inner surface of the lower housing and divide the sealed chamber into a first part, a second part, and a middle part.

In some examples, the first part is located on a side of the sealed chamber facing the rear end of the cell assembly, and the second part is located on a side of the sealed chamber facing the front end of the cell assembly.

In some examples, the middle part is opposite to the multiple air cavities in the up and down direction.

A battery pack is configured to supply power to a power tool. The battery pack includes a housing; a cell assembly disposed in the housing and including multiple stacked cell units; elastic pads separately disposed between adjacent ones of the multiple cell units, where air cavities are formed between the elastic pads and the adjacent ones of the multiple cell units; a sealing member disposed at least on the surface of the cell assembly, where the sealing member and the housing form a sealed chamber; and an air-permeable element connecting with the air cavities and connecting with the air outside the sealed chamber.

In some examples, the air-permeable element includes an air-permeable body and multiple air-permeable pin ends, and the multiple air-permeable pin ends are connected to the air-permeable body.

A power tool includes a battery pack for supplying power to the power tool. The battery pack includes a housing; a cell assembly disposed in the housing and including multiple stacked cell units; elastic pads separately disposed between adjacent ones of the multiple cell units, where air cavities are formed between the elastic pads and the adjacent ones of the multiple cell units; a sealing member disposed at least on the surface of the cell assembly, where the sealing member and the housing form a sealed chamber; and an air-permeable element partially disposed on the side surface of the cell assembly and extending into multiple air cavities along the first direction, where the air-permeable element connects with the air outside the sealed chamber.

In some examples, the air-permeable element includes an air-permeable body and multiple air-permeable pin ends, and the multiple air-permeable pin ends are connected to the air-permeable body.

In some examples, the air-permeable body is disposed on the side surface of the cell assembly, and one of the multiple air-permeable pin ends is at least partially located in one of the multiple air cavities.

A battery pack is configured to supply power to a power tool. The battery pack includes a housing; a cell assembly located in the housing and including a positive terminal of the cell assembly and a negative terminal of the cell assembly; a battery pack interface disposed on the surface of the housing; a battery pack terminal located in the battery pack interface and including a charging terminal of the battery pack and a discharging terminal of the battery pack, where the charging terminal of the battery pack is electrically connected to the positive terminal of the cell assembly or the negative terminal of the cell assembly through a charging path of the battery pack; and the discharging terminal of the battery pack is electrically connected to the positive terminal of the cell assembly or the negative terminal of the cell assembly through a discharging path of the battery pack; and a protection element disposed in the charging path and the discharging path at the same time.

In some examples, the battery pack includes a charge connector and a discharge connector, where the charge connector is disposed in the charging path, and the discharge connector is disposed in the discharging path.

In some examples, the charge connector is electrically connected to the charging terminal of the battery pack through a circuit board.

In some examples, the discharge connector is electrically connected to the discharging terminal of the battery pack.

In some examples, the front end of the protection element is configured to be electrically connected to the positive terminal of the cell assembly or the negative terminal of the cell assembly.

In some examples, the rear end of the protection element is electrically connected to the charge connector.

In some examples, the rear end of the protection element is electrically connected to the charge connector through a wire.

In some examples, the protection element is configured to be one of a blade fuse, a wrapped fuse, a chip fuse, and other fuses.

In some examples, the charge connector and the discharge connector are made of conductive material.

In some examples, the cell assembly includes multiple cell units.

In some examples, the charging path is different from the discharging path.

A battery pack is configured to supply power to a power tool. The battery pack includes a housing including an upper housing and a lower housing; a cell assembly disposed in the housing; a support plate disposed between the upper housing and the lower housing; a circuit board fixed on the upper surface of the support plate; and a terminal assembly partially fixed to the upper surface of the support plate. The terminal assembly includes multiple battery pack terminals, where each of the multiple battery pack terminals includes a terminal clamping portion and a terminal pole piece; and a terminal support seat for fixing the multiple battery pack terminals. The terminal assembly in some examples includes a terminal protection device fixed to the terminal support seat, where the terminal protection device is formed with multiple accommodation spaces, and the multiple accommodation spaces are independent of each other.

In some examples, the multiple battery pack terminals are separately located in the multiple accommodation spaces.

In some examples, a gap exists between the inner surface of each of the multiple accommodation spaces and the terminal clamping portion.

In some examples, the gap is adaptable to the reversible elastic deformation of the terminal clamping portion.

In some examples, the terminal protection device is formed with a straight groove extending along the front and rear direction, where the straight groove is opposite to the terminal clamping portion in the up and down direction.

In some examples, the terminal pole piece is electrically connected to the circuit board through a wire.

In some examples, the terminal protection device is configured to be plastic material.

The terminal protection device is configured to be insulating material.

In some examples, the cell assembly includes multiple cell units.

A battery pack is configured to supply power to a power tool. The battery pack includes a housing; a cell assembly disposed in the housing and including multiple stacked cell units; an elastic assembly including multiple elastic pads, where the multiple elastic pads are separately disposed between adjacent ones of the multiple cell units, and the multiple elastic pads and the adjacent ones of the multiple cell units form multiple air cavities; a sealing member disposed at least on the surface of the cell assembly, where the sealing member and the housing form a sealed chamber; and an air-permeable device partially disposed on the side surface of the cell assembly. The air-permeable device includes a first element, a second element, and a connector, where the first element and the second element are fixed through the connector; and the connector is connected to or formed with an air-permeable passage, the air-permeable passage connects with the multiple air cavities, and the air-permeable passage connects with the air outside the sealed chamber.

In some examples, the first element is partially disposed on the side surface of the cell assembly.

In some examples, the multiple elastic pads are configured to be deformation-reversible material.

In some examples, each of the multiple elastic pads is configured to be thermally conductive material or includes a heat conducting component.

In some examples, the cell assembly is disposed in the sealed chamber.

In some examples, the sealing member is formed through a glue filling process.

In some examples, the second element is configured to be polycarbonate (PC).

In some examples, the thickness range of the connector is configured to be greater than or equal to 0.05 mm and less than or equal to 1 mm.

In some examples, the connector is configured to be adhesive backing.

A battery pack is configured to supply power to a power tool. The battery pack includes a housing; a cell assembly disposed in the housing and including multiple stacked cell units; a deformation assembly including multiple deformation elements, where the multiple deformation elements are separately disposed between adjacent ones of the multiple cell units, and the multiple deformation elements and the adjacent ones of the multiple cell units form multiple air cavities; a sealing member disposed at least on the surface of the cell assembly, where the sealing member and the housing form a sealed chamber; and an air-permeable device partially disposed on the side surface of the cell assembly. The air-permeable device includes at least a first element and a second element, where the first element and the second element are fixed through a connector; at least one air-permeable passage is formed on or connected to the first element or the second element; and the at least one air-permeable passage connects with the multiple air cavities or connects with the multiple air cavities through the deformation assembly, and the at least one air-permeable passage connects with the air outside the sealed chamber.

In some examples, the first element is partially disposed on the side surface of the cell assembly.

In some examples, the deformation of the multiple deformation elements is configured to adapt to the multiple air cavities.

In some examples, each of the multiple deformation elements is configured to be thermally conductive material or includes a heat conducting component.

In some examples, the multiple deformation elements are configured to be air-permeable material.

In some examples, the cell assembly is disposed in the sealed chamber.

In some examples, the sealing member is formed through a glue filling process.

In some examples, the first element is configured to be modified polypropylene (MPP).

In some examples, the second element is configured to be PC.

### BRIEF DESCRIPTION OF THE DRAWINGS

FIG. 1 is a structural view of a power tool as an example;

FIG. 2 is a structural view of a battery pack;

FIG. 3 is an exploded view of the battery pack in FIG. 2;

FIG. 4 is a partial exploded view of the battery pack in FIG. 2;

FIG. 5 is a structural view of a battery pack terminal in FIG. 2;

FIG. 6 is a structural view of a terminal protection device of the battery pack in

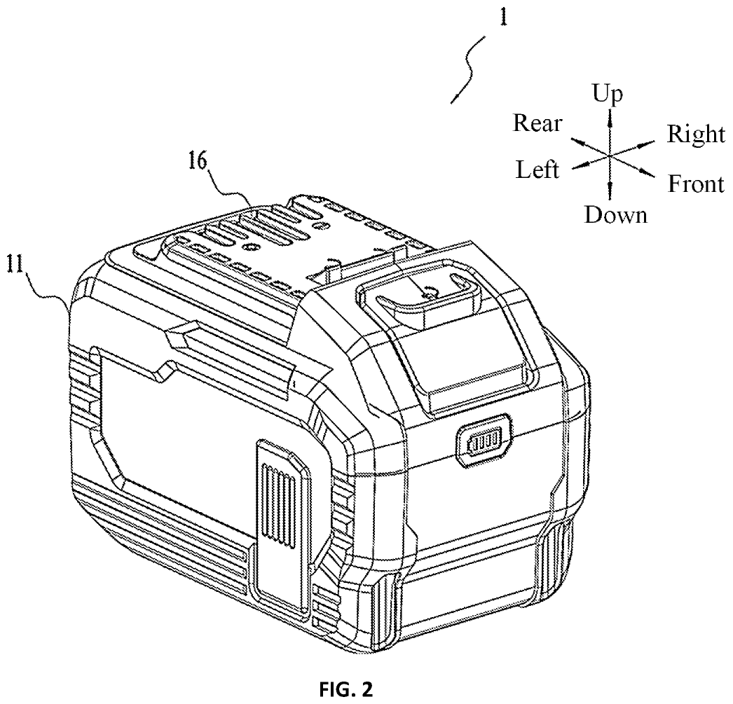

FIG. 2;

FIG. 7 is a structural view of a protection element of the battery pack in FIG. 2;

FIG. 8 is a structural view of a protection element of the battery pack in FIG. 2 from another perspective;

FIG. 9 is a schematic diagram of a charging path and a discharging path of a battery pack;

FIG. 10 is a schematic diagram of a charging path and a discharging path of a battery pack according to another example;

FIG. 11 is a partial exploded view of the battery pack in FIG. 2;

FIG. 12 is a structural view of an air-permeable element;

FIG. 13 is a structural view of an air-permeable element and a cell assembly;

FIG. 14 is a structural view of an air-permeable element and a sealing member;

FIG. 15 is a sectional view of the elements shown in FIG. 14;

FIG. 16 is a partial enlarged view of part A in FIG. 15;

FIG. 17 is a partial enlarged view corresponding to part A in another example;

FIG. 18 is a partial enlarged view corresponding to part A in another example;

FIG. 19 is a structural view of elastic pads in another example;

FIG. 20 is a structural view of separating ribs in another example;

FIG. 21 is an exploded view of a battery pack according to another example;

FIG. 22 is a structural view of a cell assembly and a deformation assembly of the battery pack in FIG. 21;

FIG. 23 is a structural diagram of a cell assembly and an air-permeable device;

FIG. 24 is a partial enlarged view of part A in FIG. 23;

FIG. 25 is an exploded view of an example of an air-permeable device;

FIG. 26 is a view illustrating an air circulation path in a battery pack;

FIG. 27 is a structural view of another example of a deformation assembly;

FIG. 28 is a partial structural view of an air-permeable device as another example;

FIG. 29 is an exploded view of the air-permeable device in FIG. 28;

FIG. 30 is a partial structural view of an air-permeable device as another example;

FIG. 31 is an exploded view of the air-permeable device in FIG. 30;

FIG. 32 is a partial structural view of an air-permeable device as another example;

and

FIG. 33 is an exploded view of the air-permeable device in FIG. 32.

### DETAILED DESCRIPTION

The present application is described below in detail in conjunction with drawings and examples.

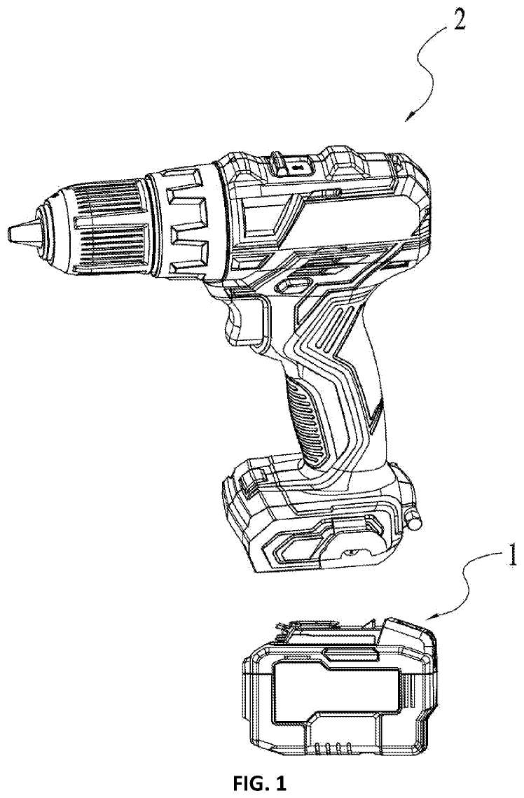

FIG. 1 shows a power tool 2 and a battery pack 1 that is applicable to the power tool 2 and supplies power to the power tool 2. In this example, the power tool 2 is an electric drill, and it is to be understood that the battery pack 1 may also be applied to a handheld power tool such as an electric wrench, an electric screwdriver, an electric hammer drill, an electric circular saw, and a sander, a table power tool such as a table saw, and an outdoor tool such as a mower, a grass trimmer, a pair of electric shears, a pruner, and an electric saw. Apparently, the following examples are part, not all, of examples of the present application.

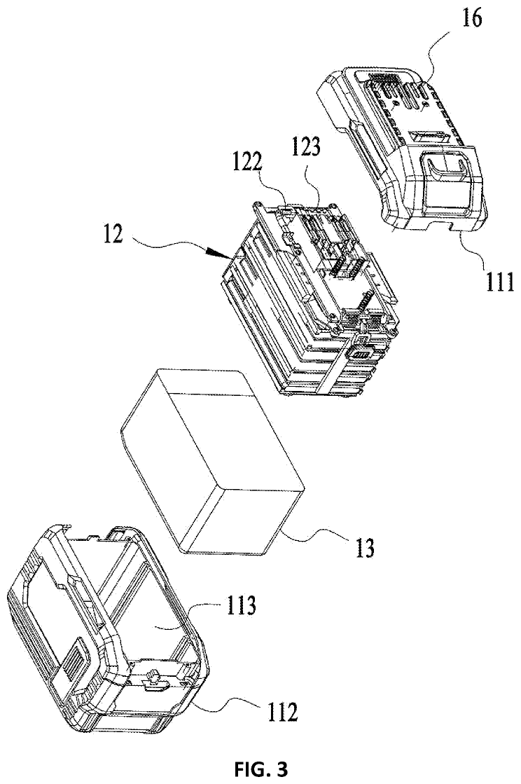

Referring to FIGS. 2 and 3, the battery pack 1 includes at least a housing 11, a cell assembly 12, and a sealing member 13. The housing 11 includes an upper housing 111 and a lower housing 112 that are assembled at an interface to form an inner cavity 113. The cell assembly 12 is disposed in the inner cavity 113 formed by the housing 11. The cell assembly 12 further includes a positive terminal 122 of the cell assembly and a negative terminal 123 of the cell assembly that are used for outputting the electrical energy of the cell assembly 12 or inputting the electrical energy to charge the cell assembly 12.

The battery pack 1 further includes a battery pack interface 16 electrically connected to at least the cell assembly 12. Specifically, the battery pack interface 16 is formed on the upper surface of the upper housing 111.

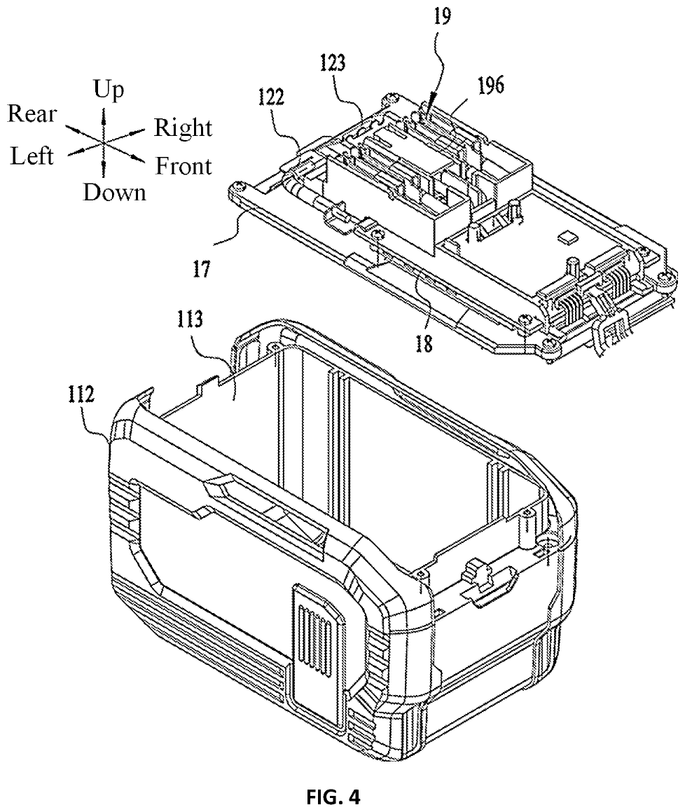

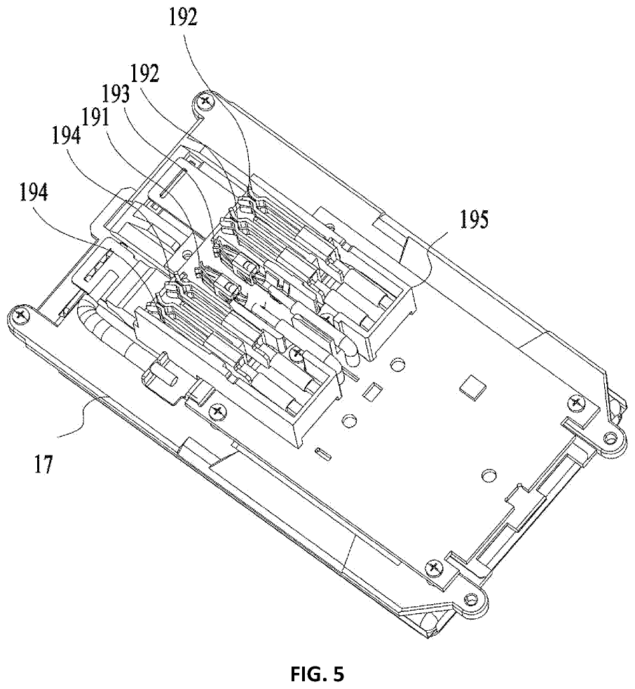

Referring to FIGS. 4 to 6, the battery pack 1 further includes a support plate 17, a main circuit board 18, and a terminal assembly 19.

The support plate 17 is disposed above the lower housing 112, and the support plate 17 and the lower housing 112 form the inner cavity 113 for accommodating the cell assembly 12. Similarly, the support plate 17 and the upper housing 111 form an accommodation space (not shown in the figure) for accommodating components such as the main circuit board 18 and the terminal assembly 19. Specifically, the support plate 17 has a flat-plate structure and is detachably connected to the lower housing 112.

The terminal assembly 19 includes a charging terminal 191 of the battery pack, negative terminals 192 of the battery pack, a communication terminal 193 of the battery pack, discharging terminals 194 of the battery pack, and a terminal support seat 195. The terminal support seat 195 is used for fixing the charging terminal 191 of the battery pack, the negative terminals 192 of the battery pack, the communication terminal 193 of the battery pack, and the discharging terminals 194 of the battery pack to the support plate 17. The charging terminal 191 of the battery pack is electrically connected to the positive terminal 122 of the cell assembly, and the charging terminal 191 of the battery pack is located in the battery pack interface 16. The negative terminals 192 of the battery pack are electrically connected to the negative terminal 123 of the cell assembly, and the negative terminals 192 of the battery pack are located in the battery pack interface 16. The charging terminal 191 of the battery pack and the negative terminals 192 of the battery pack are configured to mate with a positive terminal (not shown) of a charger and a negative terminal (not shown) of the charger to input the electrical energy to the battery pack 1.

In some examples, the charger further includes a communication terminal (not shown) of the charger, and the charger is connected to the communication terminal 193 of the battery pack through the communication terminal of the charger to communicate with the battery pack 1. The charger converts alternating current power into direct current power. The electrical energy passes through a positive terminal of the charger, the charging terminal 191 of the battery pack, the positive terminal 122 of the cell assembly, the negative terminal 123 of the cell assembly, and the negative terminals 192 of the battery pack and returns to a negative terminal of the charger, forming a charging circuit for the battery pack 1. The charger inputs the electrical energy to the cell assembly 12 through the charging circuit. Moreover, the communication terminal 193 of the battery pack is located in the battery pack interface 16 and used for communicating with the connected power tool 2 or charger. As a specific example, the terminal of the battery pack 1 clamps the terminal of the charger with an elastic force from two sides in the left and right direction. Therefore, in the process of mounting the battery pack 1 to the charger, the terminal of the charger is guided by the battery pack interface 16 and inserted into the terminal of the battery pack 1 so that the terminal of the charger is clamped by the terminal of the battery pack 1, thereby achieving the electrical connection between the charger and the battery pack 1.

The circuit board 18 is fixed on the upper side of the support plate 17, is connected in series between the cell assembly 12 and the battery pack interface 16, and is used for collecting an electrical signal related to the battery pack 1. In some examples, the circuit board 18 is connected in series between the cell assembly 12 and the communication terminal 193 of the battery pack and used for transmitting the information of the battery pack 1 through the communication terminal 193 of the battery pack to the power tool 2 or charger attached to the battery pack 1. Specifically, the information of the battery pack 1 includes the charge current of the battery pack 1, the temperature, voltage, and internal resistance of the cell assembly 12, and the like. Since the information of the battery pack 1 is generally detected by a sensor, the battery pack 1 further includes a detection sensor. One or more detection sensors may be provided. In some examples, the detection sensor may be a temperature sensor disposed on the surface of the cell assembly 12, and the temperature sensor may be specifically a thermistor. The detection sensor may also be a voltage sensor for detecting the voltage of the cell assembly 12.

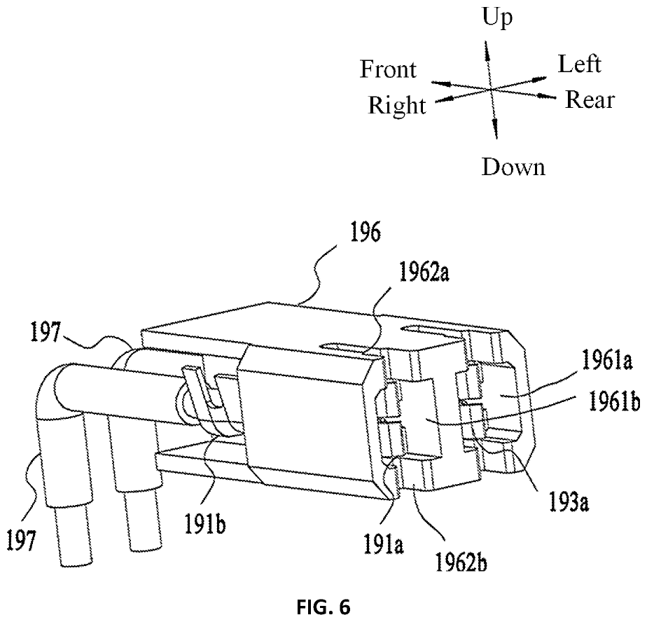

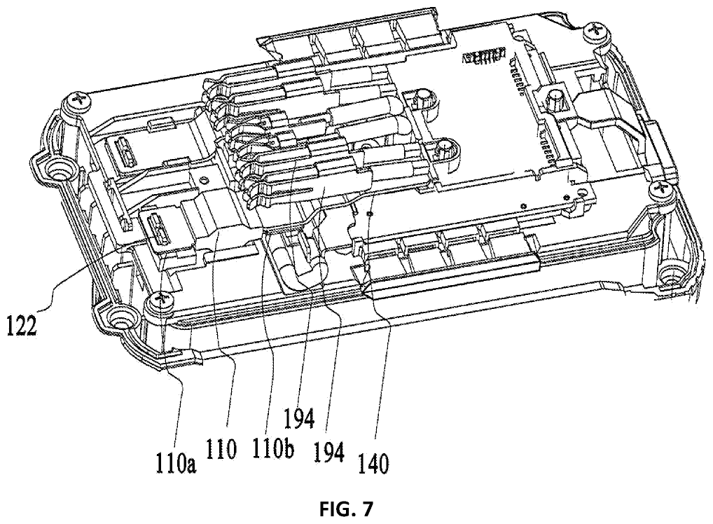

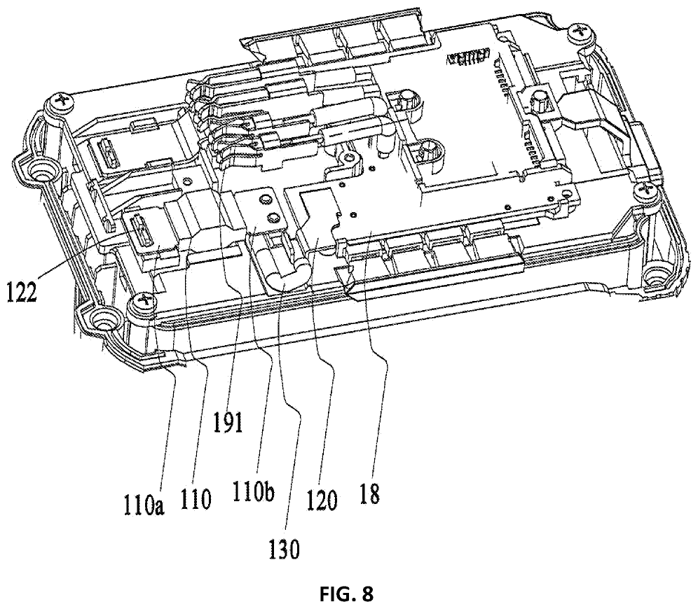

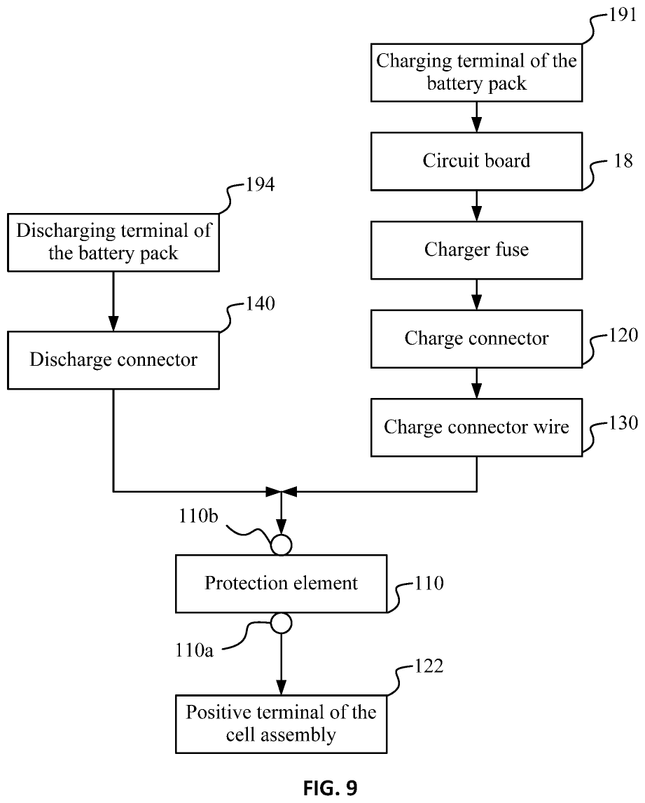

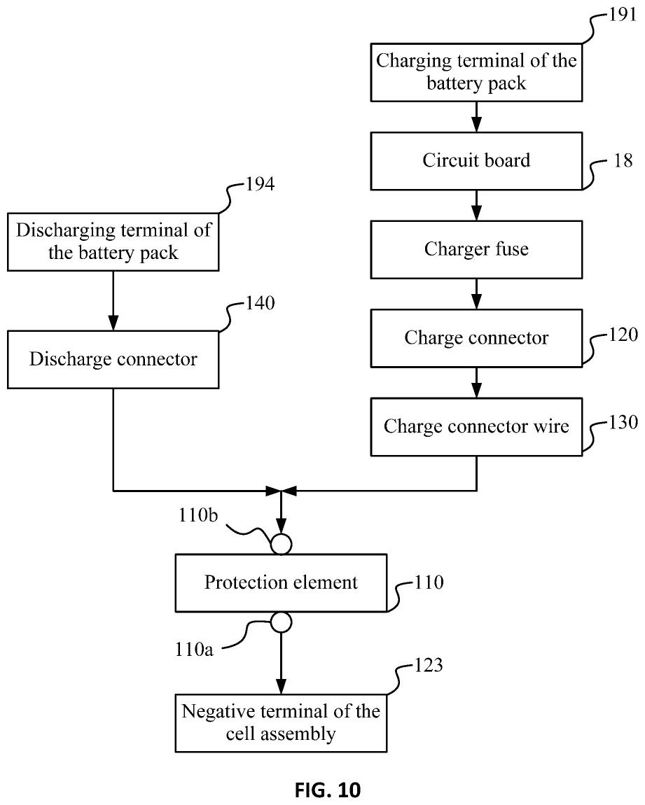

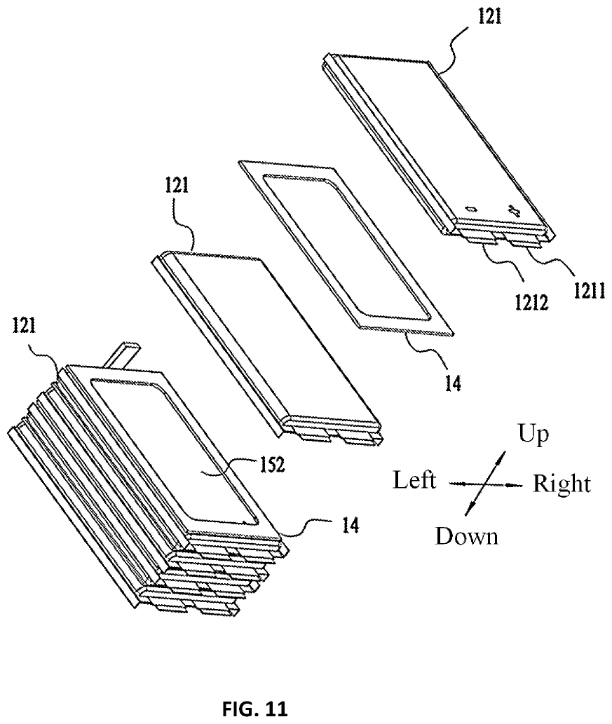

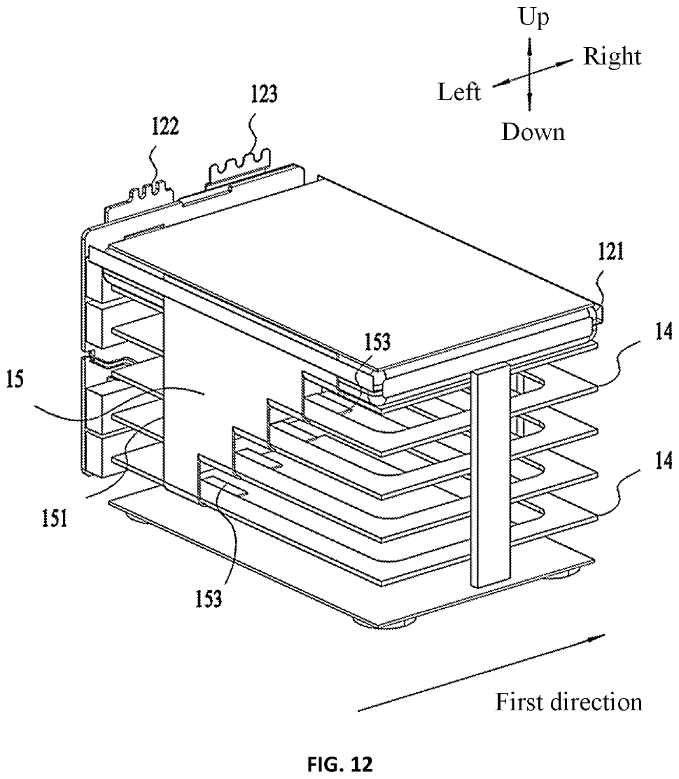

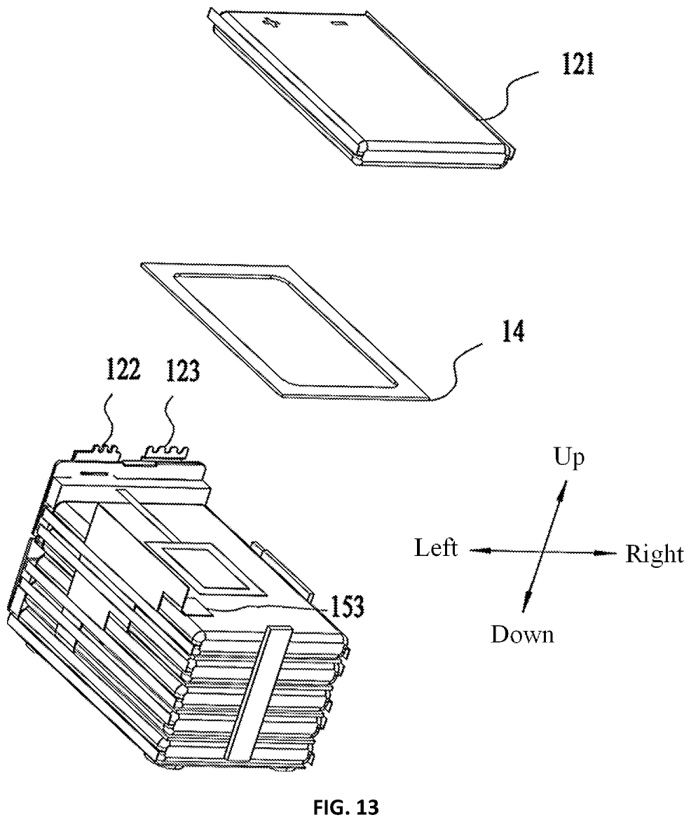

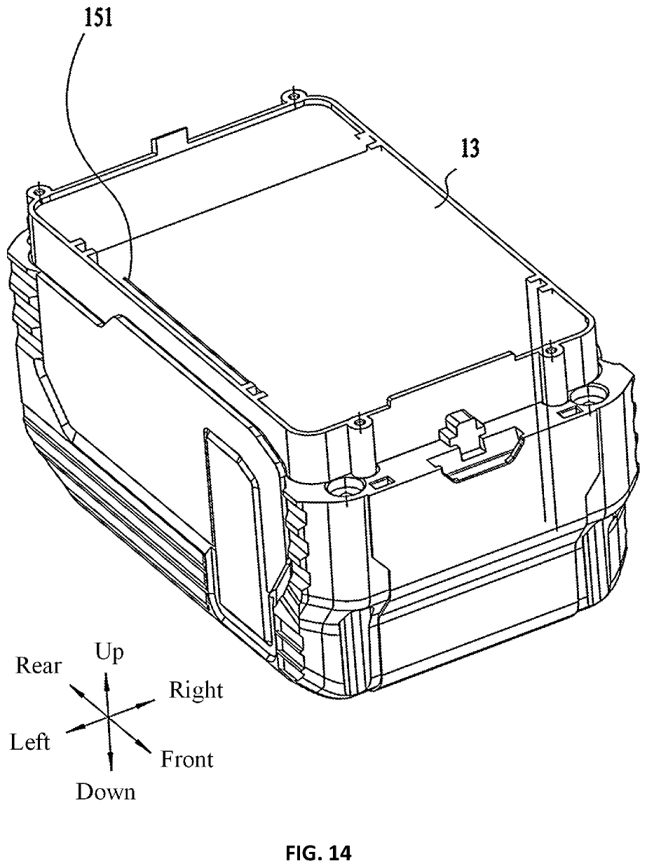

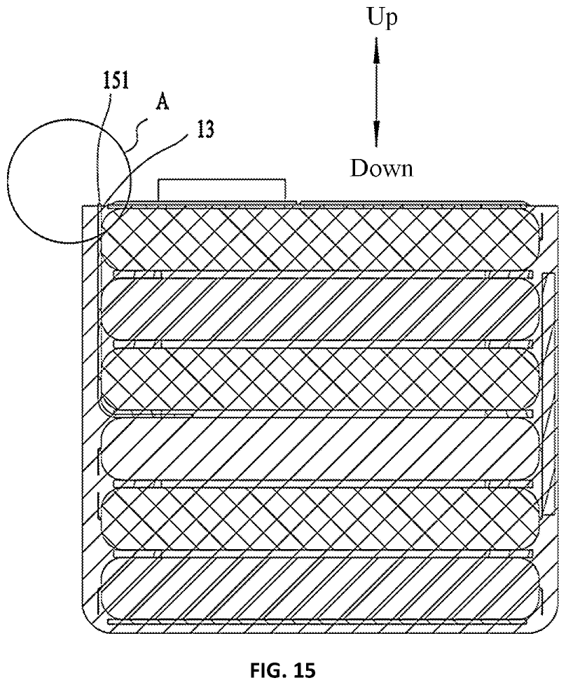

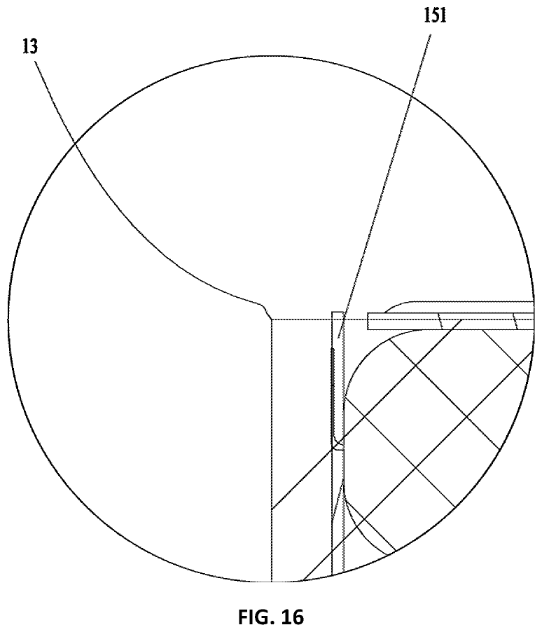

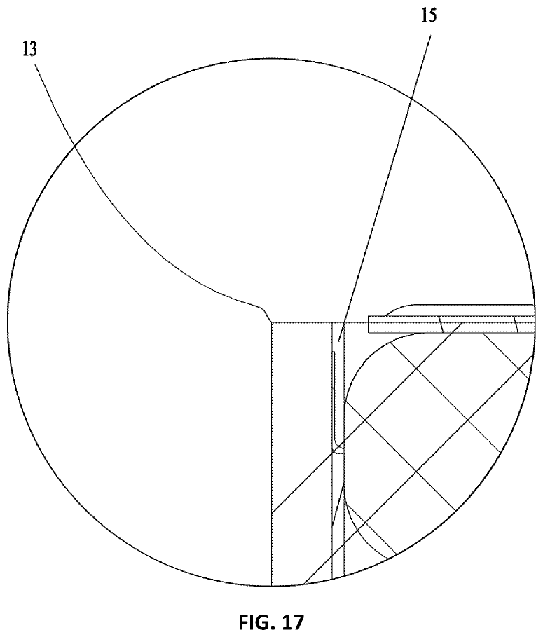

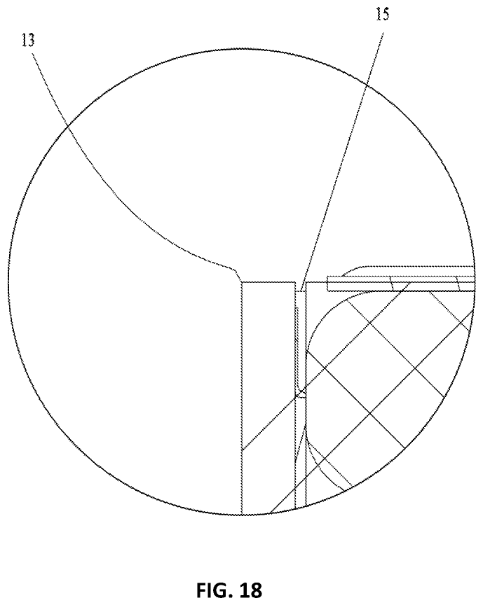

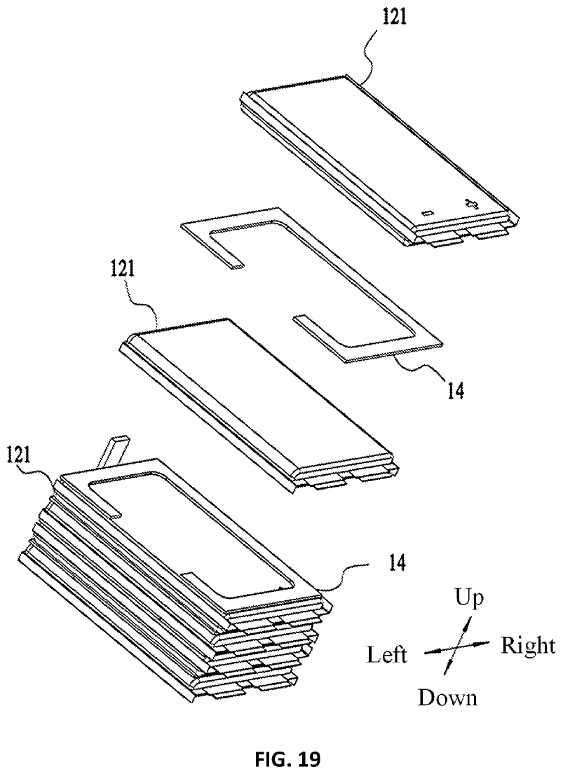

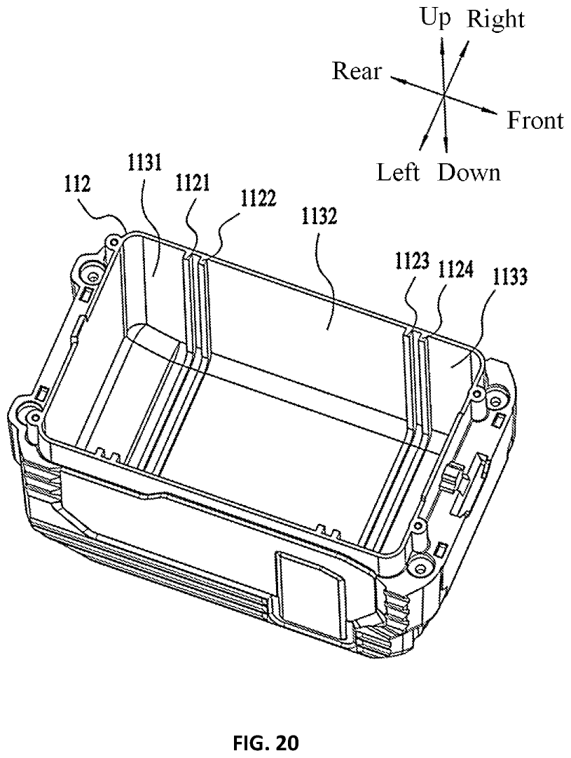

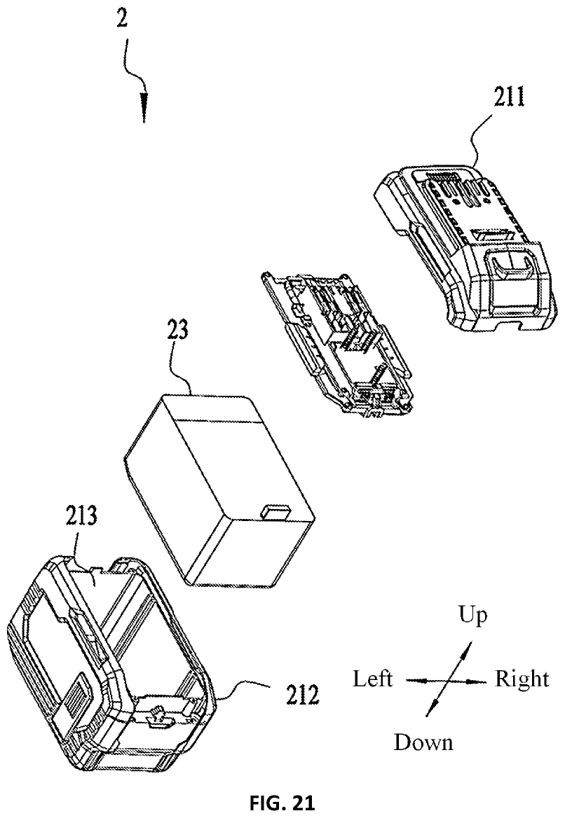

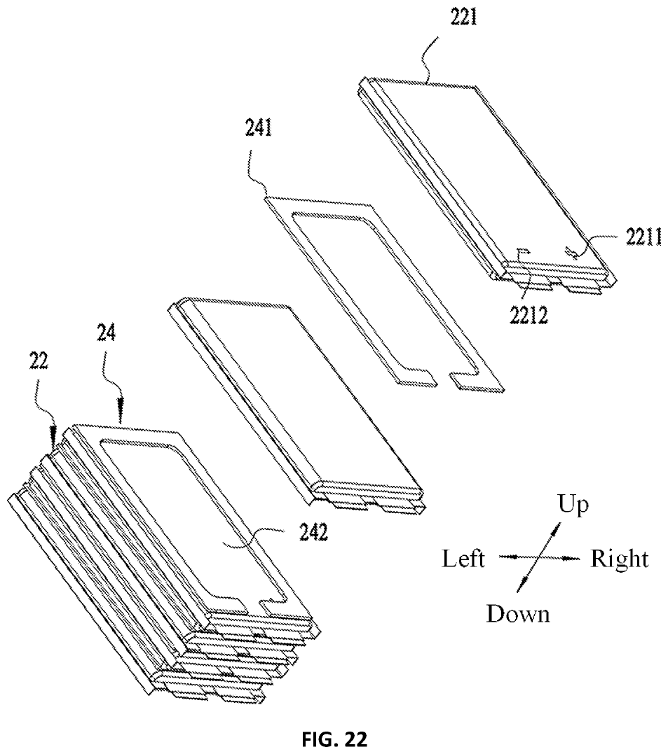

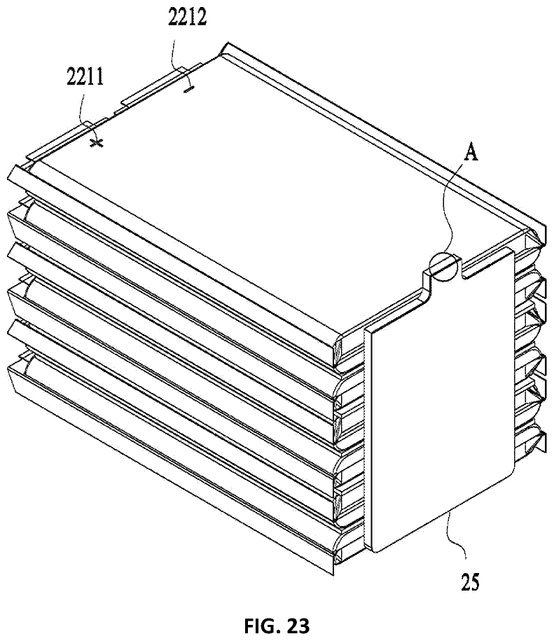

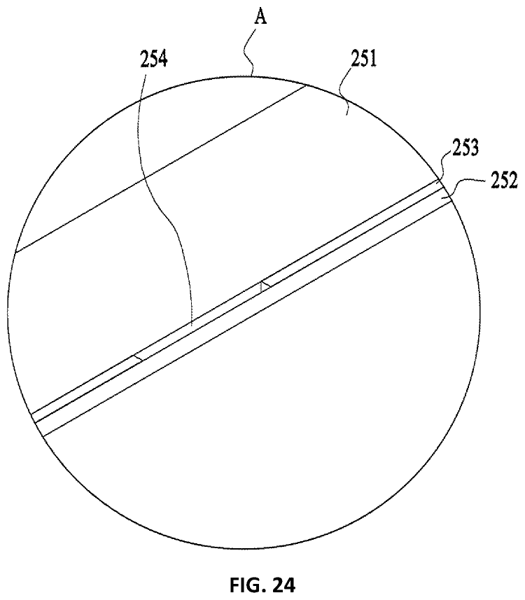

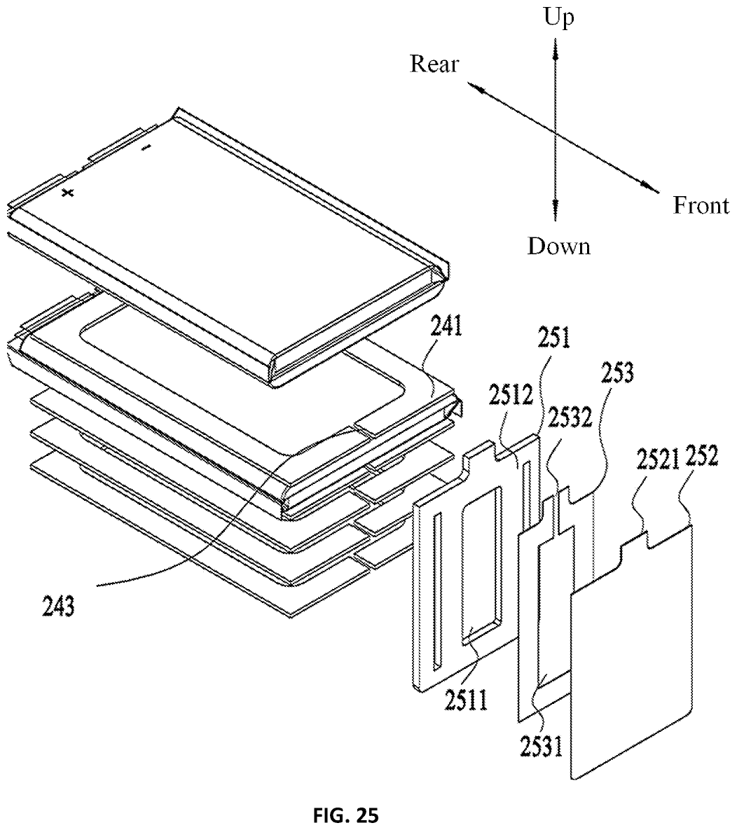

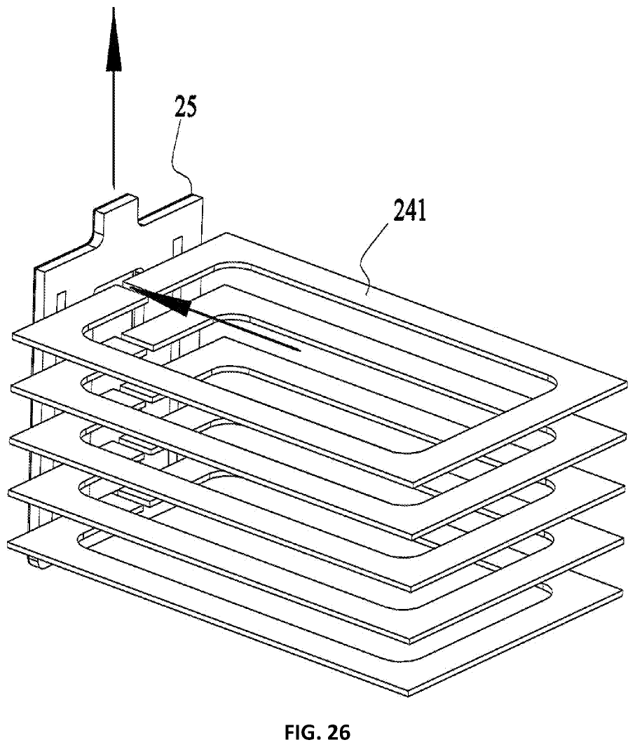

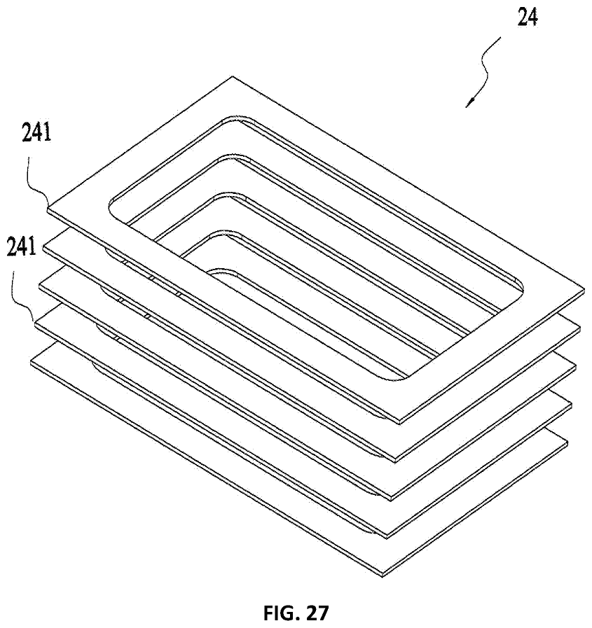

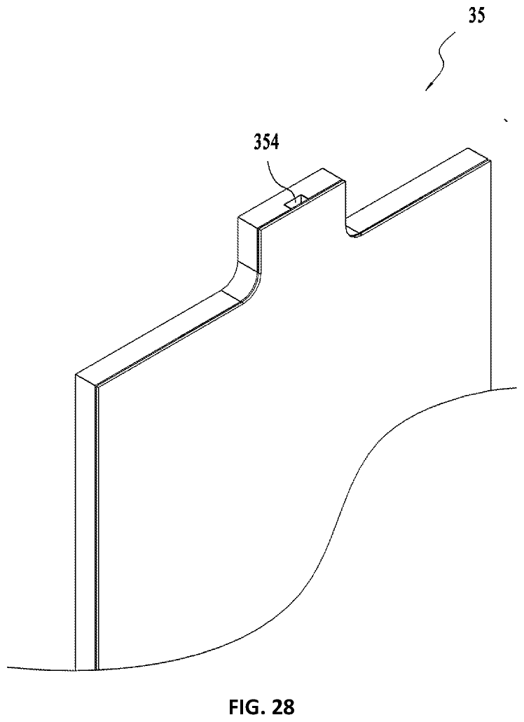

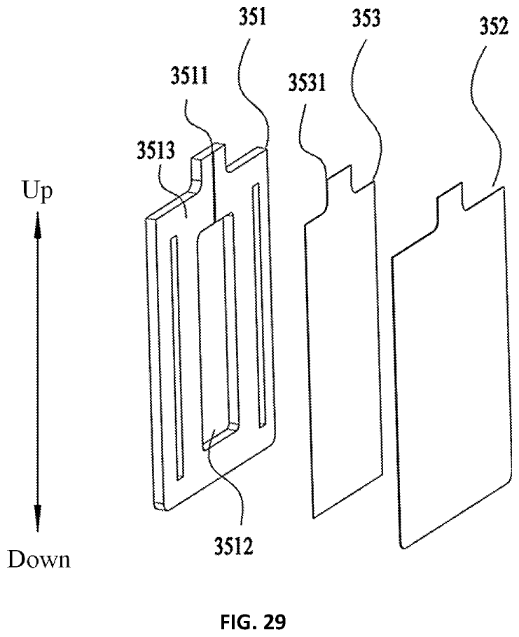

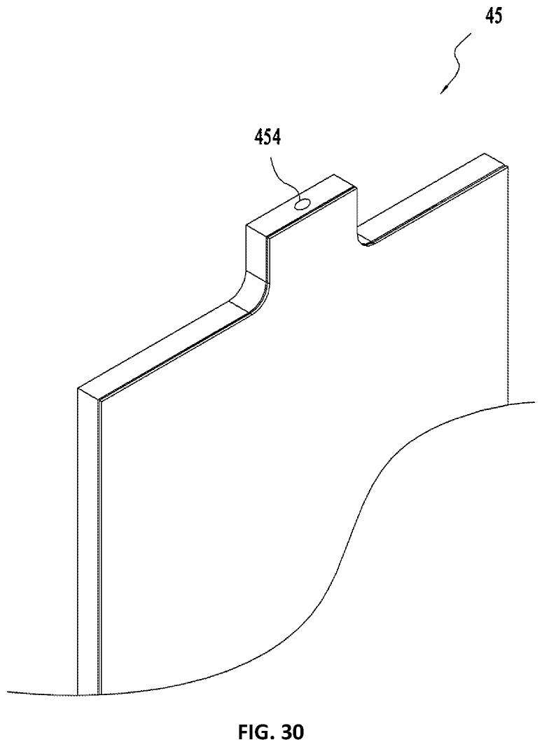

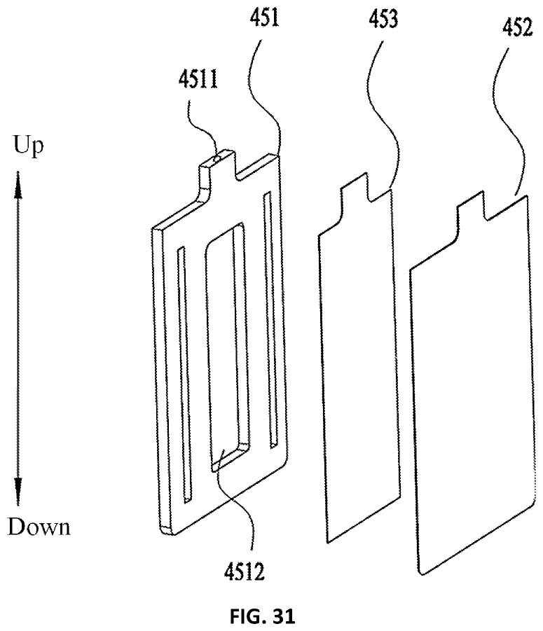

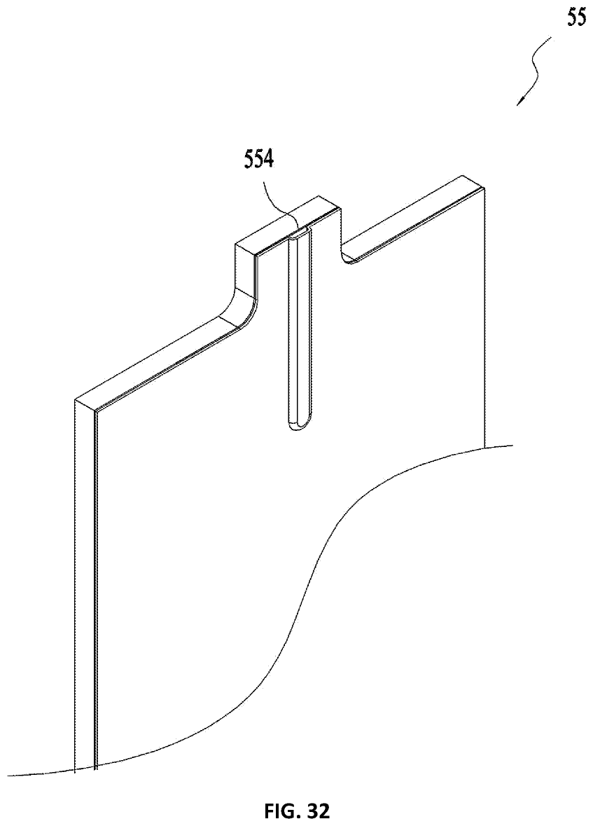

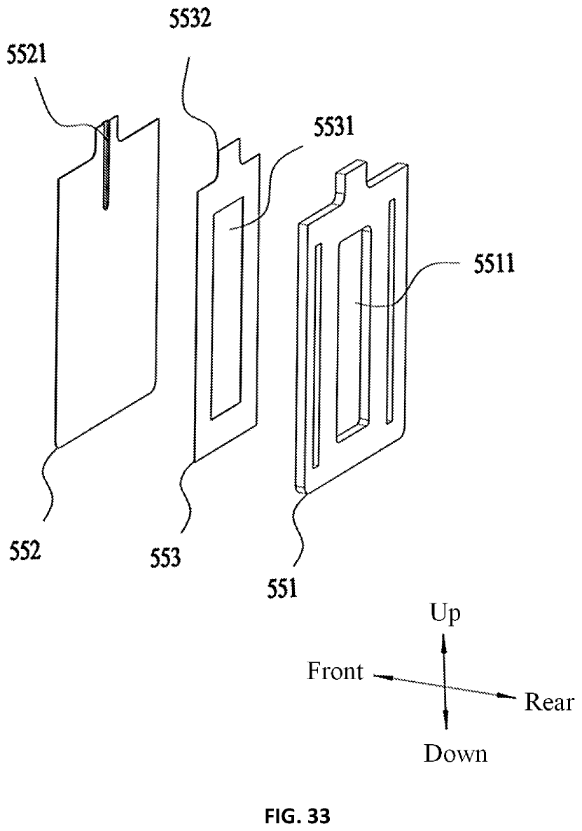

The battery pack 1 further includes a terminal protection device 196 fixed above the terminal support seat 195, and the terminal support seat 195 is fixed above the support plate 17. The terminal protection device 196 is provided with an accommodation space 1961a and an accommodation space 1961b that are independent of each other. Specifically, the charging terminal 191 of the battery pack and the communication terminal 193 of the battery pack are disposed in the accommodation space 1961a and the accommodation space 1961b, respectively, and the accommodation space 1961a and the accommodation space 1961b are used for protecting the charging terminal 191 of the battery pack and the communication terminal 193 of the battery pack. As a specific example, as shown in FIG. 6, since the terminal protection device 196 has a symmetrical structure, the charging terminal 191 of the battery pack and the terminal protection device 196 are used as examples for the detailed description. Specifically, the upper part and the lower part of the terminal protection device 196 are provided with a straight groove 1962a and a straight groove 1962b opposite to a charging terminal clamping portion 191a in the up and down direction respectively, thereby providing a reserved space in the up and down direction when the positive terminal of the charger is inserted into the charging terminal 191 of the battery pack. Optionally, a certain reserved space is provided between the charging terminal clamping portion 191a and the inner side surface of the accommodation space 1961a and used for adapting to the reversible elastic deformation of the charging terminal clamping portion 191a and providing a cooling space for the charging terminal 191 of the battery pack. A charging terminal pole piece 191b is located in the accommodation space and placed on the surface of the terminal protection device 196. The charging terminal pole piece 191b is electrically connected to the circuit board 18 through a wire 197. In this example, the electrical connection between the wire 197 and the charging terminal pole piece 191b is achieved by tin wire welding. In the assembly process, the charging terminal 191 of the battery pack is mounted into the terminal protection device 196 along the front and rear direction so that the charging terminal 191 of the battery pack is completely located in the accommodation space 1961a, and the charging terminal pole piece 191b is electrically connected to the wire 197 by welding, thereby achieving the shock absorbing and antiwear effect. The terminal protection device 196 is made of insulating material. Optionally, the insulating material such as plastic, ceramic, or rubber may be used.

It is to be noted here that the mounting manner of the communication terminal 193 of the battery pack and the terminal protection device 196 is consistent with the preceding steps and is not repeated here. In addition, the present application is not limited to setting the charging terminal 191 of the battery pack and the communication terminal 193 of the battery pack in the same terminal protection device 196. Other terminals of the battery pack may also be packaged and protected. Further, the charging terminal 191 of the battery pack and the communication terminal 193 of the battery pack may also be packaged in the accommodation spaces of the independent terminal protection device.

In some examples, as shown in FIGS. 7 to 10, the battery pack 1 further includes a protection element 110, where the protection element 110 is disposed on a discharging path and used for disconnecting the discharging path when the discharging path of the battery pack 1 fails, thereby protecting the battery pack 1 and the power tool 2.

In some examples, the discharging terminal 194 of the battery pack is connected to a discharge connector 140, the protection element 110, and the positive terminal 122 of the cell assembly in sequence, forming the discharging path of the battery pack 1.

In some other examples, the discharging terminal 194 of the battery pack is connected to the discharge connector 140, the protection element 110, and the negative terminal 123 of the cell assembly in sequence, forming the discharging path of the battery pack 1.

The protection element 110 includes a rear end 110b of the protection element and a front end 110a of the protection element. The rear end 110b of the protection element is electrically connected to the discharge connector 140. In some examples, when the discharging terminal 194 of the battery pack is electrically connected to the positive terminal 122 of the cell assembly, the front end 110a of the protection element is connected to the positive terminal 122 of the cell assembly. In some examples, when the discharging terminal 194 of the battery pack is electrically connected to the negative terminal 123 of the cell assembly, the front end 110a of the protection element is electrically connected to the negative terminal 123 of the cell assembly.

In some examples, the protection element 110 is turned off when the discharge current of the battery pack 1 is greater than or equal to a preset current value. Specifically, the protection element 110 is configured to be turned off to cut off the discharging path when the discharge current flowing through the discharging path is greater than or equal to the preset current value so that the battery pack 1 stops outputting the electrical energy, thereby improving the safety of the battery pack 1. In some examples, when the discharge current rises abnormally to the preset current value, the protection element 110 gets fused to cut off the discharging path.

In some examples, the battery pack 1 is a battery pack with different charging and discharging ports, and the protection element 110 is disposed in the discharging path and the charging path at the same time so that it is ensured that after the protection element 110 in the discharging path of the battery pack 1 is turned off, the battery pack 1 cannot be charged, and the charging path and the discharging path are not the same path.

In some examples, the charging terminal 191 of the battery pack is connected to the circuit board 18, a charger fuse (not shown in the figure), a charge connector 120, a charge connector wire 130, the protection element 110, and the positive terminal 122 of the cell assembly in sequence, forming the charging path of the battery pack 1. The charge connector wire 130 is connected to the rear end 110b of the protection element.

In some other examples, the charging terminal 191 of the battery pack is connected to the circuit board 18, the charger fuse (not shown in the figure), the charge connector 120, the charge connector wire 130, the protection element 110, and the negative terminal 123 of the cell assembly in sequence, forming the charging path of the battery pack 1. The charge connector wire 130 is connected to the rear end 110b of the protection element.

When the protection element 110 is turned off due to the failure of the discharging path of the battery pack 1, the charging operation cannot be completed due to the turn-off of the protection element 110 in the charging path. In this example, the protection element 110 may specifically be one of a blade fuse, a wrapped fuse, a chip fuse, and other fuses, which is not limited here. In addition, the charge connector 120 and the discharge connector 140 are made of materials with good electrical conductivity, which is not limited here. Optionally, the charger fuse is located on the surface of the circuit board 18 and may be a three-terminal fuse. When the value of the current flowing through the charging path is abnormal, the three-terminal fuse gets fused due to high temperature so that the battery pack 1 is protected and no longer performs the charging operation.

Referring to FIGS. 3 and 11, the battery pack 1 further includes the sealing member 13 and multiple elastic pads 14. The cell assembly 12, the sealing member 13, and multiple elastic pads 14 are all disposed in the housing 11. The cell assembly 12 includes multiple cell units 121. The cell unit 121 includes a positive electrode 1211 of the cell unit and a negative electrode 1212 of the cell unit that are used for outputting the electrical energy of the cell unit 121 or inputting the electrical energy to charge the cell unit 121. Generally, the multiple cell units 121 are connected in series, in parallel, or in series and in parallel to form the cell assembly 12. Specifically, the voltage of a single cell unit 121 is 4.2 V. The cell unit 121 further includes a cell unit housing (not shown in the figure) for packaging the cell to prevent the leakage of the compound in the cell. In some specific examples, the package may be an aluminum plastic film but is not limited to the aluminum plastic film. As a specific example, the multiple cell units 121 are stacked and arranged in sequence along the up and down direction.

The sealing member 13 is partially located on the upper surface of the cell assembly 12, and the sealing member 13 and the lower housing 112 form a sealed chamber (not shown in the figure) for sealing the cell assembly 12 in the lower housing 112 of the battery pack 1. In this example, the sealing member 13 is formed through glue filling. After the cell assembly 12 is put into the lower housing 112, the sealant is filled from the upper surface of the cell assembly 12 into the lower housing 112 to seal the cell assembly 12 in the lower housing 112.

Multiple elastic pads 14 are separately disposed between adjacent cell units 121, and the elastic pads 14 are opposite to the cell units 121 in the up and down direction. The external dimension of the elastic pad 14 is basically the same as the external dimension of the cell unit 121. Since the cell unit 121 expands in volume at high temperatures or during charging, to provide enough space for expansion and have a better heat dissipation effect, a through hole may be disposed in the middle part of the elastic pad 14, the upper surface of the elastic pad 14 is in contact with the lower surface of the cell unit 121 in the adjacent upper layer, and the lower surface of the elastic pad 14 is in contact with the upper surface of the cell unit 121 in the adjacent lower layer so that the elastic pad 14, the cell unit 121 in the adjacent upper layer, and the cell unit 121 in the adjacent lower layer form air cavities 152. In this example, the elastic pad 14 is configured to have a shape of homocentric rectangles, is made of deformation-reversible material, and has a better heat conduction effect. In this example, the elastic pad 14 may be made of sponge material or other materials with a better heat dissipation effect.

Referring to FIGS. 12 and 13, the battery pack further includes an air-permeable element 15 for achieving the balance of the air pressure inside and outside the battery pack and implementing the waterproof and dustproof function. The air-permeable element 15 is integrally disposed in the housing 11 of the battery pack. The air-permeable element 15 connects with multiple air cavities 152 and also connects with the air outside the sealed chamber (not shown in the figure) formed by the sealing member 13 and the lower housing 112. Specifically, the air-permeable element 15 is partially disposed on the side surface of the cell assembly 12 and located in the multiple air cavities 152. In this example, the air-permeable element 15 is provided with multiple air-permeable pin ends 153, and each air-permeable pin end 153 is in contact with the upper surface or lower surface of the corresponding elastic pad 14, extends along the first direction to the corresponding air cavity 152, and is used for achieving the balance of the air pressure inside and outside the sealed chamber formed by the sealing member 13 and the lower housing 112. The air-permeable element 15 further includes an air-permeable body 151 disposed on the side surface of the cell assembly 12, and the air-permeable body 151 is connected to the multiple air-permeable pin ends 153.

Referring to FIGS. 14 to 16, the air-permeable body 151 is at least partially located in the air outside the sealed chamber. FIG. 15 shows a partial sectional view of the battery pack 1. As shown at part A in the figure, the air-permeable body 151 protrudes from the upper surface of the sealing member 13 in the up and down direction. It is to be noted that the height by which the upper surface of the air-permeable body 151 is higher than the upper surface of the sealing member 13 is not limited in this example and may be selected according to actual design conditions.

As another possible example, as shown in FIG. 17, the air-permeable body 151 is flush with the sealing member 13 in the up and down direction. According to this design, the upper surface of the air-permeable body 151 may be in contact with the air outside the preceding sealed chamber so that the balance of the air pressure inside and outside the preceding sealed chamber can also be achieved.

As another possible example, as shown in FIG. 18, the upper surface of the sealing member 13 is not in a plane, and the upper surface of the air-permeable body 151 is flush with the upper surface of a groove of the sealing member 13. According to this design, the upper surface of the air-permeable body 151 may be in contact with the air outside the preceding sealed chamber so that the balance of the air pressure inside and outside the sealed chamber can also be achieved.

In this example, during the assembly process of the air-permeable element 15, the air-permeable pin ends 153 of the air-permeable element 15 are fixed on the surfaces of the corresponding multiple elastic pads 14 by glue, and the air-permeable body 151 of the air-permeable element 15 is fixed on the side surface of the cell assembly 12 by glue. After the air-permeable element 15 and the cell assembly 12 are placed in the lower housing 112, the glue and the lower housing 112 form the sealed chamber by filling the glue on the upper surface of the cell assembly 12, so as to seal the cell assembly 12 in the sealed chamber. The air-permeable element 15 in this example is not limited to being disposed on the left side surface of the cell assembly 12 as shown in FIG. 12 and may be disposed on any or multiple of the front surface, rear surface, left surface, and right surface of the cell assembly 12. The air-permeable element 15 is made of waterproof air-permeable paper which has a waterproof rating of IPX7 and has a good air-permeable function. To improve the effect of air pressure balance inside and outside the sealed chamber, the air-permeable element 15 in this example uses the waterproof air-permeable paper with a thickness ranging from 0.3 mm to 4 mm. When the battery pack 1 is stored at high temperatures or in the process of charging and discharging, the air pressure in the sealed chamber increases due to the temperature rise, and the internal and external air pressure is balanced through the air-permeable element 15, so as to achieve the balance of the air pressure inside and outside the sealed chamber in the housing 11, avoid the deformation of the housing 11 caused by the excessively high air pressure in the sealed chamber, increase the service life of the battery pack 1, and enhance the safety and performance stability of the battery pack 1.

In some examples, since the cell unit 121 expands in volume at high temperatures or during charging, to provide enough space for expansion and have a better heat dissipation effect, as shown in FIG. 19, an opening is disposed on the left side or/and the right side of the elastic pad 14, that is, a complete shape of homocentric rectangles is not formed.

In some examples, as shown in FIG. 20, multiple separating ribs are formed on or connected to the inner surface of the lower housing 112 and include a separating rib 1121, a separating rib 1122, a separating rib 1123, and a separating rib 1124. Specifically, the separating rib 1121 and the separating rib 1122 are disposed at the rear end of the lower housing 112, and the separating rib 1123 and the separating rib 1124 are disposed at the front end of the lower housing 112. The distance between the separating rib 1121 and the separating rib 1122 in the front and rear direction is about twice the width of the separating rib 1121 or the separating rib 1122. Similarly, the distance between the separating rib 1123 and the separating rib 1124 in the front and rear direction is about twice the width of the separating rib 1123 or the separating rib 1124. The separating rib 1121 or the separating rib 1122 is substantially located at one-third of the lower housing 112 from the rear end, and the separating rib 1123 or the separating rib 1124 is substantially located at one-third of the lower housing 112 from the front end. In this example, a sealing strip is disposed between the separating rib 1121 and the separating rib 1122, and a sealing strip is also disposed between the separating rib 1123 and the separating rib 1124. Specifically, the sealing strip in this example is configured to be a sponge strip.

In this example, the separating rib 1121, the separating rib 1122, the separating strip 1123, and the separating strip 1124 are U-shaped. In some other examples, the separating rib 1121 is used as an example, and the part of the separating rib 1121 on the bottom of the lower housing 112 and the part of the separating rib 1121 on the side of the lower housing 112 are not in the same plane and are staggered from each other. Other separating ribs are also set according to this method and are not described in detail.

During the assembly process of the cell assembly 12, the cell assembly 12 is placed in the inner cavity 113 formed by the housing 11, and the separating ribs on the lower housing 112 are fully in contact with the lower surface and side surfaces of the cell assembly 12 and divide the inner cavity 113 in which the cell assembly 12 is mounted into a first part 1131, a second part 1133, and a middle part 1132. In this example, the sealant is filled on the upper surface of the cell assembly 12 in the first part 1131 and the second part 1133 in the up and down direction, the first part 1131 and the second part 1133 are sealed with glue, and the middle part 1132 forms an independent air-permeable cavity (not shown in the figure). When the battery pack 1 is stored at high temperatures or in the process of charging and discharging, the air pressure balance is achieved through the elastic pads 14, so as to achieve the balance of the air pressure inside and outside the sealed chamber formed by the sealing member 13 and the lower housing 112, avoid the deformation of the housing 11 caused by the excessively high air pressure in the sealed chamber, reduce the cost, simplify the structure, reduce the amount of filled glue, and reduce the weight of the battery pack 1.

Next, other examples in the present application for achieving the balance of the air pressure inside and outside the battery pack are introduced.

Referring to FIGS. 21 and 22, a battery pack 2 includes an upper housing 211 and a lower housing 212 that form an inner cavity 213. A cell assembly 22, a sealing member 23, and a deformation assembly 24 are all disposed in the inner cavity 213. The sealing member 23 and the lower housing 212 form a sealed chamber (not shown in the figure), and the cell assembly 22 is disposed in the sealed chamber.

The deformation assembly 24 includes multiple deformation elements 241. The deformation elements 241 are separately disposed between adjacent cell units 221, and the multiple deformation elements 41 are opposite to the cell units 221 in the up and down direction. Specifically, the external dimension of the deformation element 241 is basically the same as the external dimension of the cell unit 221. Since the cell unit 221 expands in volume at high temperatures or during charging, to provide enough space for expansion and have a better heat dissipation effect, a through hole may be disposed in the middle part of each of the multiple deformation elements 241, the upper surface of the deformation element 241 is in contact with the lower surface of the cell unit 221 in the adjacent upper layer, and the lower surface of the deformation element 241 is in contact with the upper surface of the cell unit 221 in the adjacent lower layer so that the deformation element 241, the cell unit 221 in the adjacent upper layer, and the cell unit 221 in the adjacent lower layer form air cavities 242. Specifically, the deformation element 241 may be made of deformation-reversible material and have a better heat conduction effect. Optionally, the deformation element 241 may be made of sponge material or other materials with a better heat dissipation effect. In addition, it is to be noted here that the material of the deformation element is not limited in the present application, and the deformation element may be adapted to the air cavity 242 through magnetic deformation or other deformation methods.

When the battery pack is stored at high temperatures or in the process of charging and discharging, the air pressure in the sealed chamber increases as the temperature rises and squeezes the cell units 221, so the air pressure squeezes the cell units 221, causes the cell units 221 to move toward two sides of a stacking surface, and finally squeezes and deforms the housing. Referring to FIG. 26, the battery pack 2 further includes an air-permeable device 25, and the balance of the air pressure inside and outside the sealed chamber is achieved through the air-permeable device 25.

Referring to FIGS. 23 to 25, the air-permeable device 25 is partially disposed on the side surface of the cell assembly 22. Specifically, the air-permeable device 25 is disposed on a side facing away from a positive electrode 2211 of the cell unit or a negative electrode 2212 of the cell unit. In this example, the air-permeable device 25 includes a first element 251, a second element 252, and a connector 253. The first element 251 is disposed on the side surface of the cell assembly 22, the first element 251 is provided with a through hole 2511 along the front and rear direction, the upper boundary of the through hole 2511 is disposed above the upper surface of the deformation assembly 24, and the lower boundary of the through hole 2511 is disposed below the lower surface of the deformation assembly 24. Specifically, the first element 251 is pasted on the side surface of the cell assembly 22 by glue. The second element 252 is fixed on the first element 251 through the connector 253. In this example, the second element 252 is made of PC, and the connector 253 is configured to be adhesive backing. At least one air-permeable passage 254 is formed on the air-permeable device 25, and the air-permeable passage 254 connects with multiple air cavities 242 and connects with the air outside the preceding sealed chamber, so as to achieve the balance of the air pressure inside and outside the sealed chamber of the battery pack 2.

The connector 253 is provided with a through hole 2531 along the front and rear direction. Specifically, the external dimension of the through hole 2531 is basically the same as the external dimension of the through hole 2511 on the first element 251. The connector 253 is provided with a straight groove 2532 above the through hole 2531 along the up and down direction. The straight groove 2532, a first side surface 2512 of the first element 251, and a first side surface 2521 of the second element 252 form the air-permeable passage 254. The arrow direction in FIG. 26 is the air circulation direction in the battery pack 2. Specifically, in the working process of the battery pack 2, the air in the air cavities 242 connects with the straight groove 2532 through the deformation elements 241, the through hole 2511 of the first element 251, and the through hole 2531 of the connector 253, so as to connect with the air outside the preceding sealed chamber and achieve the balance of the air pressure inside and outside the sealed chamber of the battery pack 2.

To further improve the effect of internal and external air pressure balance, specifically, the deformation element 241 may be set in an incomplete shape of homocentric rectangles. Referring to FIG. 25, a cutout 243 is disposed on a side of the deformation element 241 connected to the air-permeable device 25. The air in the air cavities 242 connects with the air outside the preceding sealed chamber through the cutouts 243 on the deformation elements 241, the through hole 2511 of the first element 251, the through hole 2531 of the connector 253, and the air-permeable passage 254, so as to achieve the balance of the air pressure inside and outside the sealed chamber of the battery pack 2. Specifically, since the connector 253 is configured to be adhesive backing, to achieve a better air pressure balance effect, optionally, the thickness of the adhesive backing may be set within a range of greater than or equal to 0.05 mm and less than or equal to 1 mm. In this example, the connector 253 may also be directly disposed on the first element 251 or the second element 252. During the assembly process of the air-permeable device 25, the first element 251 and the second element 252 are directly assembled.

Since the deformation element 241 in this example has good air permeability, the deformation element 241 may also be set to a shape as shown in FIG. 27. The air in the air cavities 242 connects with the air outside the sealed chamber through the deformation elements 241, the through hole 2511 of the first element 251, the through hole 2531 of the connector 253, and the air-permeable passage 254, so as to achieve the balance of the air pressure inside and outside the sealed chamber of the battery pack 2.

In some examples, the air-permeable device 35 may also be implemented in other forms. Specifically, as shown in FIGS. 28 and 29, a first element 351 is formed with a through hole 3512, and a straight groove 3511 extending in the up and down direction is formed on a first side surface 522 of the first element 351. The straight groove 3511 connects with the through hole 3512 and is located above the through hole 3512. In this example, the depth of the straight groove 3511 is not greater than the thickness of the first element 351. The straight groove 3511 and a first side surface 3531 of a connector 353 form an air-permeable passage 354. The air in the air cavities connects with the air outside the sealed chamber through the through hole 3512 of the first element 351 and the air-permeable passage 354, so as to achieve the balance of the air pressure inside and outside the sealed chamber of the battery pack. To better balance the air pressure inside and outside the sealed chamber in the battery pack, the first element 351 may optionally be made of MPP or rubber, and the thickness of the first element 351 may be optionally set within a range of greater than or equal to 2 mm and less than or equal to 10 mm. It is to be noted here that the depth and width of the straight groove 3511 may be set according to the specific use environment.

The first element 351, a second element 352, and the connector 353 in this example are mounted in the same manner as in the preceding examples. The details are not repeated here.

In some examples, as shown in FIGS. 30 and 31, a first element 451 is formed with a first through hole 4512, and the first element 451 is further formed with a second through hole 4511 extending along the up and down direction. The second through hole 4511 is located above the first through hole 4512 and connects with the first through hole 4512 to form an air-permeable passage 454. In this example, the second through hole 4511 forms the air-permeable passage 454. The air in the air cavities connects with the air outside the sealed chamber through the first through hole 4512 of the first element 451 and the air-permeable passage 454, so as to achieve the balance of the air pressure inside and outside the sealed chamber of the battery pack. Specifically, the first element 451 is made of MPP, and the thickness of the first element 451 is set within a range of greater than or equal to 2 mm and less than or equal to 10 mm. It is to be noted here that the diameter of the second through hole 4511 is set according to the specific use environment of the battery pack.

The first element 451, a second element 452, and a connector 453 in this example are mounted in the same manner as in the preceding examples. The details are not repeated here.

In some examples, as shown in FIGS. 32 and 33, a first element 551 is formed with a first through hole 5511 extending along the front and rear direction, and a connector 553 is formed with a second through hole 5531 extending along the front and rear direction, where the first through hole 5511 and the second through hole 5531 connect with each other and have substantially the same dimension. A second element 552 is formed with a groove 5521 disposed in the up and down direction. The groove 5521 and a front side surface 5532 of the connector 553 form an air-permeable passage 554. The air in the air cavities connects with the air outside the sealed chamber through the first through hole 5511 of the first element 551, the second through hole 5531 of the connector 553, and the air-permeable passage 554, so as to achieve the balance of the air pressure inside and outside the sealed chamber of the battery pack. In this example, the second element 552 is made of PC, and the thickness of the second element 552 is set within a range of greater than or equal to 0.5 mm and less than or equal to 2 mm. It is to be noted here that the depth of the groove 5521 may be set according to the specific use environment of the battery pack.

The first element 551, the second element 552, and the connector 553 in this example are mounted in the same manner as in the preceding examples. The details are not repeated here.

It is to be noted that the air-permeable device in the preceding examples is higher than the upper surface of the sealing member in the up and down direction of the battery pack. It is to be understood that the air-permeable device may also be flush with or lower than the upper surface of the sealing member in the up and down direction, and the difference is that when the cell units in the battery pack are sealed through glue filling, special treatment is required to make the air-permeable passage connect with the air outside the sealed chamber in the battery pack.

In the preceding examples, the battery pack achieves the balance of the air pressure inside and outside the sealed chamber of the battery pack through the air-permeable passage on the air-permeable device. It is ensured that when the battery pack is stored at high temperatures or in the process of charging and discharging, the air pressure in the sealed chamber does not increase significantly as the temperature rises, thereby improving the safety performance of the battery pack. The air-permeable device in the preceding examples has a simple structure, a simple assembly process, and a low cost and is easy to implement.

What is claimed is:

1. A battery pack, configured to supply power to a power tool, comprising:
a housing;
a cell assembly disposed in the housing and comprising a plurality of stacked cell units;
elastic pads separately disposed between adjacent ones of the plurality of cell units, wherein air cavities are formed between the elastic pads and the adjacent ones of the plurality of cell units;
a sealing member disposed at least on a surface of the cell assembly, wherein the sealing member and the housing form a sealed chamber; and
an air-permeable element connecting with the air cavities and connecting with air outside the sealed chamber.

2. The battery pack of claim 1, wherein the air-permeable element comprises an air-permeable body and a plurality of air-permeable pin ends, and the plurality of air-permeable pin ends are connected to the air-permeable body.

3. The battery pack of claim 2, wherein the air-permeable body is disposed on the side surface of the cell assembly, and one of the plurality of air-permeable pin ends is at least partially located in one of the plurality of air cavities.

4. The battery pack of claim 3, wherein an upper surface of the air-permeable body is higher than an upper surface of the sealing member.

5. The battery pack of claim 1, wherein the air-permeable element is made of a waterproof air-permeable material.

6. The battery pack of claim 5, wherein a thickness of the air-permeable element is greater than 0.3 mm and less than 4 mm.

7. The battery pack of claim 1, wherein an opening is formed on a side of each of the elastic pads facing the air-permeable element, and air in the opening connects with air in one of the plurality of air cavities.

8. A system, comprising:
a power tool; and
a battery pack for supplying power to the power tool;
wherein the battery pack comprises:
a housing;
a cell assembly disposed in the housing and comprising a plurality of stacked cell units;
elastic pads separately disposed between adjacent ones of the plurality of cell units, wherein air cavities are formed between the elastic pads and the adjacent ones of the plurality of cell units;
a sealing member disposed at least on a surface of the cell assembly, wherein the sealing member and the housing form a sealed chamber; and
an air-permeable element partially disposed on a side surface of the cell assembly and extending into a plurality of air cavities along a first direction, wherein the air-permeable element connects with air outside the sealed chamber.

9. The system of claim 8, wherein the air-permeable element comprises an air-permeable body and a plurality of air-permeable pin ends, and the plurality of air-permeable pin ends are connected to the air-permeable body.

10. The system of claim 9, wherein the air-permeable body is disposed on the side surface of the cell assembly, and one of the plurality of air-permeable pin ends is at least partially located in one of the plurality of air cavities.

11. A battery pack, configured to supply power to a power tool, comprising:
a housing;
a cell assembly disposed in the housing and comprising a plurality of stacked cell units;
an elastic assembly comprising a plurality of elastic pads, wherein the plurality of elastic pads are separately disposed between adjacent ones of the plurality of cell units, and the plurality of elastic pads and the adjacent ones of the plurality of cell units form a plurality of air cavities;
a sealing member disposed at least on a surface of the cell assembly, wherein the sealing member and the housing form a sealed chamber; and
an air-permeable device partially disposed on a side surface of the cell assembly;
wherein the air-permeable device comprises a first element, a second element, and a connector, the first element and the second element are fixed through the connector, the connector is connected to or formed with an air-permeable passage, the air-permeable passage connects with the plurality of air cavities, and the air-permeable passage connects with air outside the sealed chamber.

12. The battery pack of claim 11, wherein the first element is partially disposed on the side surface of the cell assembly.

13. The battery pack of claim 11, wherein the plurality of elastic pads comprises a deformation-reversible material.

14. The battery pack of claim 11, wherein each of the plurality of elastic pads comprises a thermally conductive material or a heat conducting component.

15. The battery pack of claim 11, wherein the cell assembly is disposed in the sealed chamber.

16. The battery pack of claim 15, wherein the sealing member is formed through a glue filling process.

17. The battery pack of claim 11, wherein the second element comprises a polycarbonate (PC).

18. The battery pack of claim 17, wherein a thickness range of the connector is greater than or equal to 0.05 mm and less than or equal to 1 mm.

19. The battery pack of claim 18, wherein the connector has an adhesive backing.

20. A battery pack, configured to supply power to a power tool, comprising:
a housing;
a cell assembly disposed in the housing and comprising a plurality of stacked cell units;
a deformation assembly comprising a plurality of deformation elements, wherein the plurality of deformation elements are separately disposed between adjacent ones of the plurality of cell units, and the plurality of deformation elements and the adjacent ones of the plurality of cell units form a plurality of air cavities;
a sealing member disposed at least on a surface of the cell assembly, wherein the sealing member and the housing form a sealed chamber; and
an air-permeable device partially disposed on a side surface of the cell assembly;
wherein the air-permeable device comprises at least a first element and a second element, the first element and the second element are fixed through a connector, at least one air-permeable passage is formed on or connected to the first element or the second element, the at least one air-permeable passage connects with the plurality of air cavities or connects with the plurality of air cavities through the deformation assembly, and the at least one air-permeable passage connects with air outside the sealed chamber.
